(19) United States
(12) Patent Application Publication
(10) Pub. No.: US 2022/0335542 A1
(43) Pub. Date: Oct. 20, 2022

(54) Method to display digital media with related data from systems for input and aggregation

(71) Applicant: Erin Oliver Jones, Rowlett, TX (US)

(72) Inventor: Erin Oliver Jones, Rowlett, TX (US)

(21) Appl. No.: 17/844,070

(22) Filed: Jun. 20, 2022

Related U.S. Application Data
(63) Continuation-in-part of application No. 17/329,236, filed on May 25, 2021.
(60) Provisional application No. 63/069,093, filed on Aug. 23, 2020.

(51) Int. Cl. G06Q 50/00; G06F 16/28; G06F 16/26

(52) U.S. Cl. CPC G06Q 50/01; G06F 16/287; G06F 16/26

(57) ABSTRACT

Method and systems of the application using user feedback from a userbase for news and scientific research replaces a comment section or forum. Method transforms user feedback into statistical data that is less ambiguous than narrative comments and provides insight into the consensus of a userbase across different categories including, but are not limited to: location, age, gender, education, religion, or political party. Searching, grouping, and filtering digital media and related data narrows the scope of information curating a unique view of user feedback and digital media. Determining what percentage of user feedback agree or disagree with the digital media displaying or indicating which digital media causes users to submit different user feedback is just as important as the news itself.

### CROSS-REFERENCE TO RELATED APPLICATIONS

This application is a continuation-in-part application of U.S. patent application Ser. No. 17/329,236, titled “Computer application to view digital content and submit rating with users data, which can be queried and filtered as a sample polling system.” filed on May 25, 2021, which is an application that claims the benefit of provisional patent application No. 63/069,093, titled “Computer application to view digital content, submit rating tied to users data, query and filter by user data, as a sample polling system”, filed on Aug. 23, 2020.

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A READ-ONLY OPTICAL DISC OR AS A TEXT FILE VIA THE OFFICE ELECTRONIC FILING SYSTEM

“Not Applicable”

### STATEMENT REGARDING PRIOR DISCLOSURES BY THE INVENTOR OR A JOINT INVENTOR

“Not Applicable”

### BACKGROUND OF THE INVENTION

### Field of the Invention

This invention relates to the field of social media applications and more particularly to the method displaying digital media and related data in conjunction with user interfaces, and systems submitting user feedback with data as input and aggregating data related to digital media as output.

### Description of Related Art

Feedback from users relating to news content and scientific research generally available through a comment section or forum is narrative-driven leading to misinterpretation and confusion. There is not meaningful information about users that write comments or differentiating an overall consensus. Lack of information allows single, potentially-biased individuals to create fact from fiction. Collecting data is often inefficient due to a small sample size, short timeframe, or segmented location.

### BRIEF SUMMARY OF THE INVENTION

Method displays digital media in conjunction with related data via user interfaces and uses systems to submit user feedback as input and aggregate user feedback as output for the application. Method uses a user interface to accept input from a user to register or verify identity. Method uses a user interface to display interactive digital media in conjunction with related data. The purpose of related data is to highlight trends, differences, changes, volumes of feedback users submit. The related data is aggregated by the algorithm from record data which is data representing the user, digital media, and user feedback in combination. Method uses a user interface to display digital media in detail and a tool for the user to select feedback which is statistically-driven. Method uses user interface to display a group of digital media, related data for digital media, group of digital media, time-controlled digital media. Method can filter digital media and data displayed on the user interface. Grouping digital media and related data allows a user a broader, generalized view. Method transfers data from 3^{rd} party or blockchain as necessary to provide security and greater context.

### BRIEF DESCRIPTION OF THE SEVERAL VIEWS OF THE DRAWING(S)

There are presently shown in the drawing embodiments which are presently preferred, it being understood, however, that the invention is not limited to the precise arrangements and instrumentalities shown.

Method and systems of the application are drawn in FIG. 1.

Method consists of the Credential User Interface 118 of the application displaying the Login Tool 101 for inputting User Input Data 124 from a user for registering or verifying identity, and the Login Button 102 transmits data to the resource on the device 111 from the user device 122.

Method consists of the Feed User Interface 119 of the application displaying interactive digital media 103 and Totaling Related Data 104, and the Search Bar 105 sending Grouping Text 127 input by user to group digital media 103 and transmits to the resource on the device 111 from the user device 122.

Method consisting of the Detailed User Interface 120 of the application displaying digital media 103 in detail and Totaled Related Data 104, with a Grouping Button 106 to group digital media 103. Method using the Input System 123 utilizing a Feedback Tool 107 for selecting User Feedback 126 and editing User Input Data 124, Meta Data 125 (including, but not limited to: publishing time, keywords, headline, and summary), into Record Data 112 uses the Submitting Button 108 transmits data to the resource on the device 111 from the user device 122.

Method consisting of the Archive User Interface 121 of the application displaying the group of digital media 103, and Totaling Related Data 104, Timing Related Data 110, Grouping Related Data 117, and a Curating Tool 109 for filtering or sorting the group of digital media 103 using the resource on the device 111 from the user device 122.

Method transmitting data through the network using the resource on the device 111 from the user device 122 to the server 113 containing the Backend System 116 of databases and algorithm storing, sending, or retrieving using a blockchain 115 or 3^{rd} party 114 data sources as needed.

FIG. 2A and FIG. 2B consisting of the workflow of the method and systems 200-220 in the detailed description.

### DETAILED DESCRIPTION OF THE INVENTION

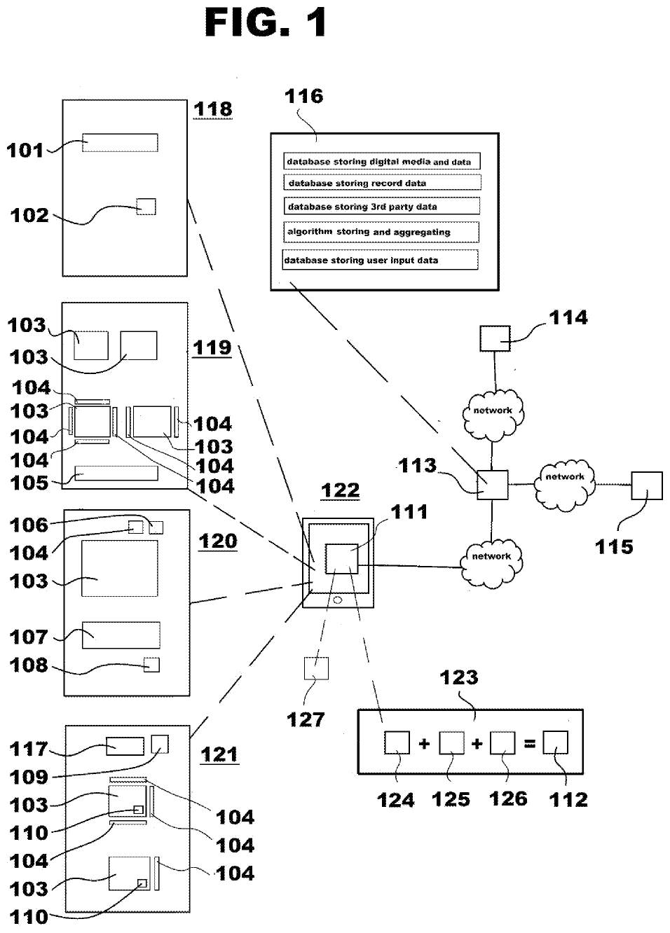

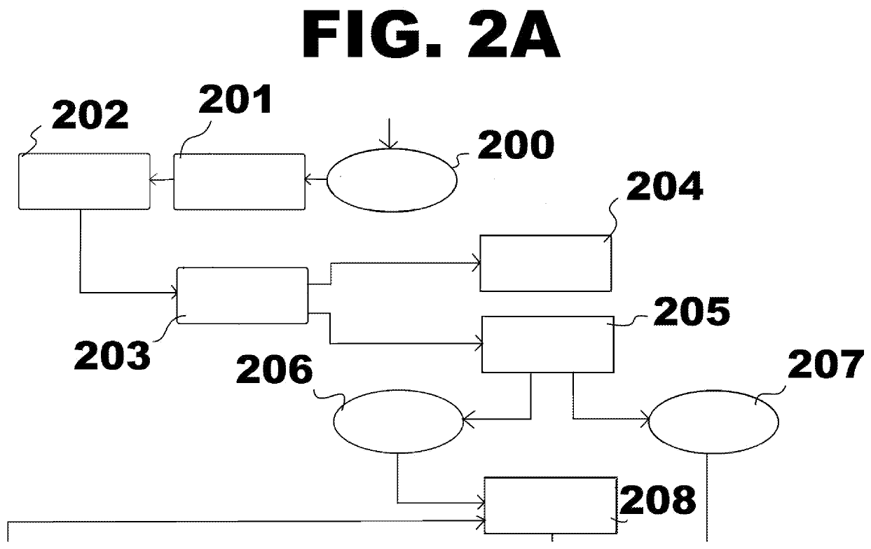

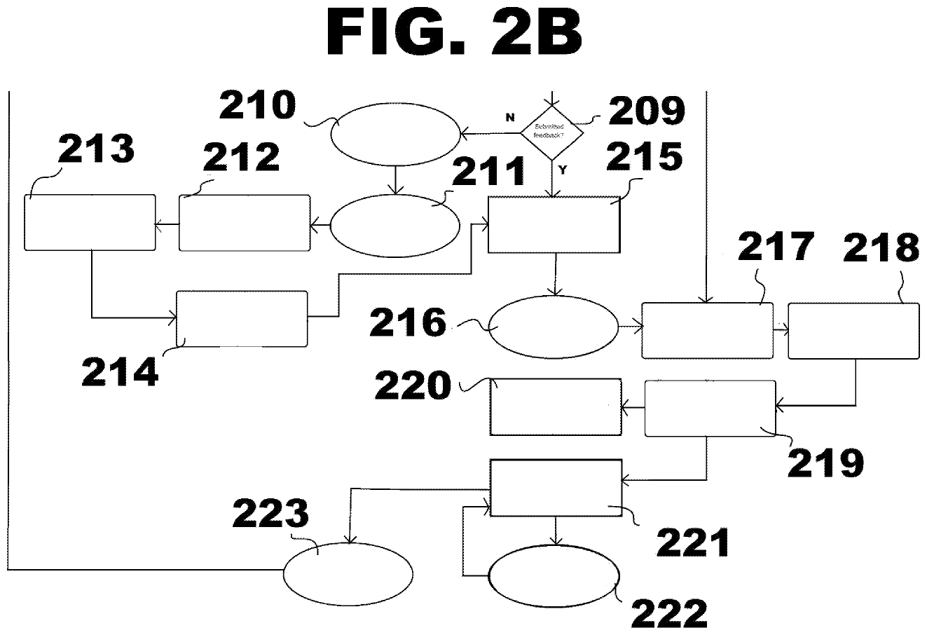

Method and systems of the application follow the steps in FIG. 2A and FIG. 2B.

Method displaying the Credential User Interface 118 using a Login Tool 101 accepting User Input Data 124 for registering ((categories of input including, but are not limited to: location, age, gender, education, religion, or political party) or verifying identity (login, email, phone number, username, and/or password) and selecting a Login Button 102 transferring to the resource on the device 111. 200

Method transferring User Input Data 124 from the resource on the device 111 to the server 113 through the network. 201

Method using the Backend System 116 containing databases and algorithm on the server 113, and data from a blockchain 115 or 3^{rd} party source 114 as needed, verifying User Input Data 124 and copying digital media 103 (including, but not limited to: written articles and videos), Meta Data 125, (including, but not limited to: publishing time, keywords, source, and summary), algorithm related data to the resource on the device 111 through the network: 202

Algorithm related data consists of, but not limited to;

Totaling Related Data 104:

Trend-based related data using ranking metrics. For example, a category is location and the algorithm calculates data by ranking digital media in each location and aggregating across all locations. Digital media 103 for each category of User Input Data 124 where Record Data 112 indicates quantity of User Feedback 126 over a period of time returns as data.

Difference-based related data comparing data for each unique element within a category of User Input Data 124. For example, a category is location and every unique location is an element in the category location. A correlation matrix identifies which elements have the lowest correlation. Digital media 103 for each category of User Input Data 124 where Record Data 112 indicates User Feedback 126 that have the lowest correlating elements returns as data.

Preference-based related data calculating a variance and average per digital media or group of digital media. For example, categories include location and gender and the net value of User Feedback 126 is within the level of variance of changing. Digital media 103 for each category of User Input Data 124 where Record Data 112 indicates net User Feedback 126 changes value or in range of changing returns as data.

Policy-based related data combining aggregated record data with data from a 3^{rd} party source 114, such as government API data, generates. For example, net User Feedback 126 from a population of a state or country can be different that the current legal policy or policy changes. Digital media 103 for each category of User Input Data 124 where Record Data 112 indicates net User Feedback 126 is different from legal policy or policy changes returns as data.

Statistic-based related data using generic mathematic functions such as percentage, sum, count, average, and variance. For example, a specified percentage of User Feedback 126 per category, such as location is similar, identifying the digital media may contain nonfactual information. Digital media 103 for each category of User Input Data 124 where Record Data 112 indicates similar User Feedback 126 in quantity returns as data.

Timing Related Data 110 that aggregates digital media 103 past a certain date or submitting User Feedback 126 is no longer available.

Grouping Related Data 117 that aggregates when grouping digital media 103 after summing Totaling Related Data 104 for digital media 103.

Method copying digital media 103 and Totaling Related Data 104 from the resource on the device 111 and displaying to the Feed User Interface 119 if the User Input Data 124 passes server 113 validation. 203

Method using the Feed User Interface 119 displaying Totaling Related Data 104 from the resource on the device 111. 204

Method using the Feed User Interface 119 displaying digital media 103 in a feed or feeds in conjunction with Totaling Related Data 104 from the resource on the device 111. 205

Method selecting digital media displaying on the Feed User Interface 119 switching to the Detailed User Interface 120 and displaying a detailed view of the digital media 103. 206

Method inputting Grouping Text 127 into the Search Bar 105 on the Feed User Interface 119 for group of digital content 103 and transferring to the resource on the device 111 and switching to the Archive User Interface 121. 207

Method of the Detailed User Interface 120 displaying the selected digital media 103 in more detail from the Feed User Interface 119 or Archive User Interface 121. 208

Method checks for a previous submission of Record Data 112 by the user pertaining to the digital media 103 displayed in detail using the resource on the device 111. 209

If no, the method using the Feedback Tool 107 that is part of the Detailed User Interface 120 selects User Feedback 126 this is in reference to the digital media 103 displayed in detail. 210

Method using a Submitting Button 108 that is part of the Detailed User Interface 120 transferring the User Feedback 126, digital media 103 to the resource on the device 111. 211

Method utilizing the Input System 123 in the resource on the device 111 creates Record Data 112 from editing the User Input Data 124, Meta Data 125, and User Feedback 126 which transfers to the server 113 through the network. 212

Method utilizing the Backend System 116 containing databases on the server 113 stores the Record Data 112 and updates algorithm related data using a blockchain 115 or 3^{rd} party data source 114 as needed and copies to the resource on the device 111. 213

Method copying the Totaled Related Data 104 from the resource on the device 111 and displaying in the Input Tool 107 that is part of the Detailed User Interface 120. 214

If Yes, the method copying the Totaled Related Data 104 from the resource on the device 111 and displaying in the Input Tool 107 that is part of the Detailed User Interface 120. 215

Method interacting with a Grouping Button 106 on the Detailed User Interface 120 for grouping digital content transfers to the resource on the device 111 and switches to the Archive User Interface 121. 216

Method transfers Grouping Text 127 or Meta Data 125 from the resource on the device 111 to the server 113 through the network. 217

Method using Grouping Text 127 or Meta Data 125 creates the group of digital content 103 and Totaling Related Data 104, Timing Related Data 110, and Grouping Related Data 117 using the Backend System 116 on the server 113, using a blockchain 115 or 3^{rd} party data source 114 as needed, and copies to the resource on the device 111 through the network. 218

Method copying the group of digital content 103 and Totaling Related Data 104, Timing Related Data 110, and Grouping Related Data 117 from the resource on the device 111 and displaying to the Archive User interface 121. 219

Method using the Archive User Interface 121 displays Totaling Related Data 104, Timing Related Data 110, Grouping Related Data 117 from the resource on the device 111. 220

Method using the Archive User Interface 121 displays the group of digital media 103 in conjunction with the Totaling Related Data 104 from the resource on the device 111. 221

Method interacts with a Curating Tool 109 that is part of the Archive User Interface 121 filtering and sorting the group of digital media 103. 222

Method interacts with the digital media 103 displaying in the Archive User Interface 121 switching to the Detailed User Interface 120 to display it in detail. 223

### SEQUENCE LISTING

“Not Applicable”

1. The method displaying digital media and related data in conjunction.

2. The method of claim 1, wherein the method utilizing systems combining inputs and aggregating data related to the digital media.
